(19) United States
(12) Patent Application Publication
(10) Pub. No.: US 2002/0099460 A1
(43) Pub. Date: Jul. 25, 2002

(54) System for facilitating elevator design

(76) Inventors: Christopher Alen Bowler, London (GB); Scott Christopher Gaskill, Simsbury, CT (US); Bruce Powell, Canton, CT (US); Omar Fathi, West Hartford, CT (US)

Correspondence Address: Thomas H. Osborn, Otis Elevator Company, Intellectual Property Dept., 10 Farm Springs, Farmington, CT, 06032, US

(21) Appl. No.: 09/768,407

(22) Filed: Jan. 24, 2001

(51) Int. Cl. G06F 17/00

(52) U.S. Cl. 700/97

(57) ABSTRACT

A computer-based system facilitates providing design information to customers or users at remote locations around the world. A design module preferably utilizes different types of information from the customer and automatically generates elevator design information for the customer's consideration. An example design module includes a first module that makes elevator system design determinations based upon expected passenger traffic patterns. Another module generates elevator system design information based upon building characteristics. A third module generates design information based upon dimensional information regarding the hoistway in which the elevator will be installed. The system preferably provides design information to the user in the form of budgeting or pricing information, written specifications and drawings as desired.

### BACKGROUND OF THE INVENTION

1. This invention generally relates to designing elevator systems. More particularly, this invention relates to a computer-based system that allows individuals from remote locations to obtain information as part of an elevator system design process.

2. Elevator systems have become a standard way of transporting passengers between different levels and buildings. Because elevator systems have gained such wide spread acceptance, there are a variety of factors that affect the design of a particular elevator system. Factors that influence elevator system design include the size of the building, the anticipated flow of passengers, the type of building use, the availability of elevator system components and local building codes and requirements, for example. Elevator system design, therefore, is not a straight forward task.

3. Elevator companies have used a variety of approaches to assist customers in developing or designing elevator systems to meet the needs of particular situations. Typically, an architect or designer contacts the elevator company and provides information to a representative of the elevator company regarding the particular situation. The elevator company representative then determines, based on the information received, appropriate design suggestions. This process may prove undesirably expensive. Although systems are known within elevator companies to assist their own personnel in this design process, there has never been an effective way of providing design suggestion information to a customer, architect or building engineer, for example.

4. There is a need for a system capable of providing design information to individuals outside of elevator companies in a cost-effective way as part of the design process. An easy-to-use system would enable various individual customers to obtain design information and make decisions on which elevator system to use or how to modify a building design, for example.

5. Prior to this invention there has not been an effective means to accomplish that end. This invention provides a system that facilitates giving elevator design information to individuals outside of elevator companies to assist in the decision-making process of designing an elevator system.

### SUMMARY OF THE INVENTION

6. In general terms, this invention is a system that facilitates providing design information to an individual customer as part of an elevator system design process. A system designed according to this invention preferably is computer-based and allows an individual from a remote location to obtain elevator system design information over a communication link such as the internet.

7. A system designed according to this invention preferably includes a design module that provides elevator system design information to an individual customer or user based upon one of a plurality of types of information provided by the individual. A communications module facilitates communication between the individual (typically at a remove location) and the design module.

8. In a preferred embodiment, the design module preferably includes three different modules that utilize three different types of information from the customer for providing the elevator system design information. A first module uses expected passenger traffic flow information. A second module uses building characteristic information. A third module utilizes information regarding the hoistway within which the elevator system will operate. At least one of these modules preferably is utilized to develop elevator system design information based upon the information provided by the customer or user.

9. The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

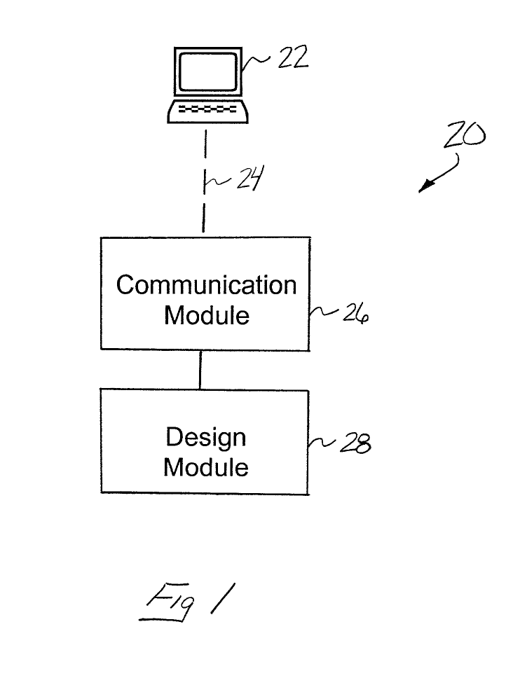

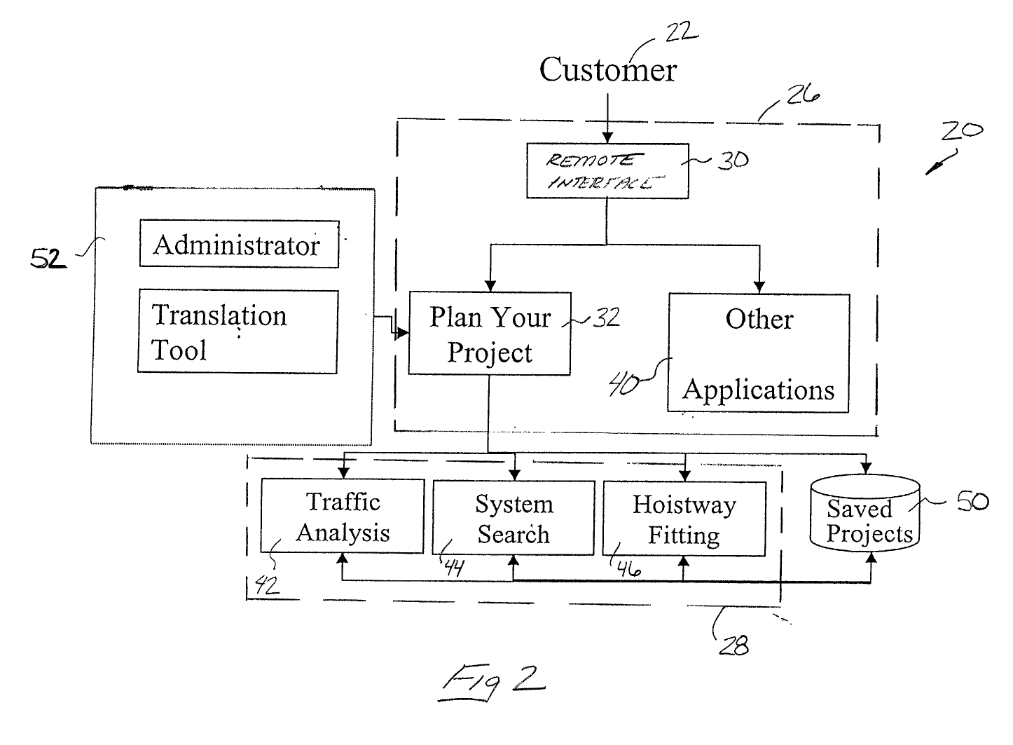

10. FIG. 1 is a diagrammatic illustration of a system designed according to this invention.

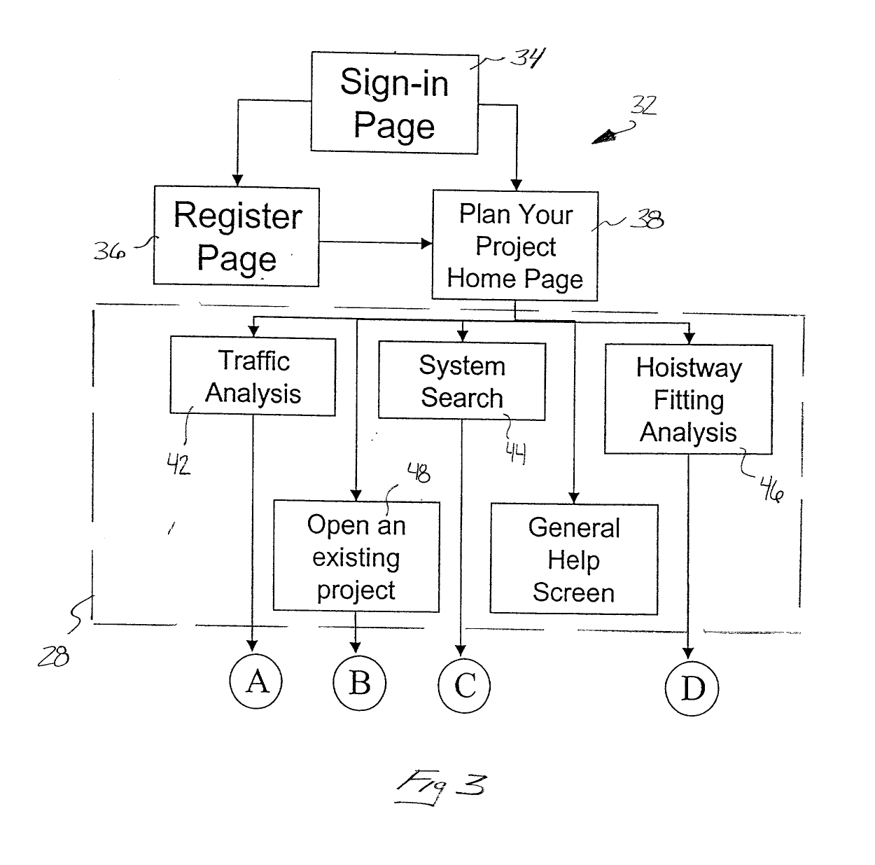

11. FIG. 2 diagrammatically illustrates more details about a system designed according to this invention.

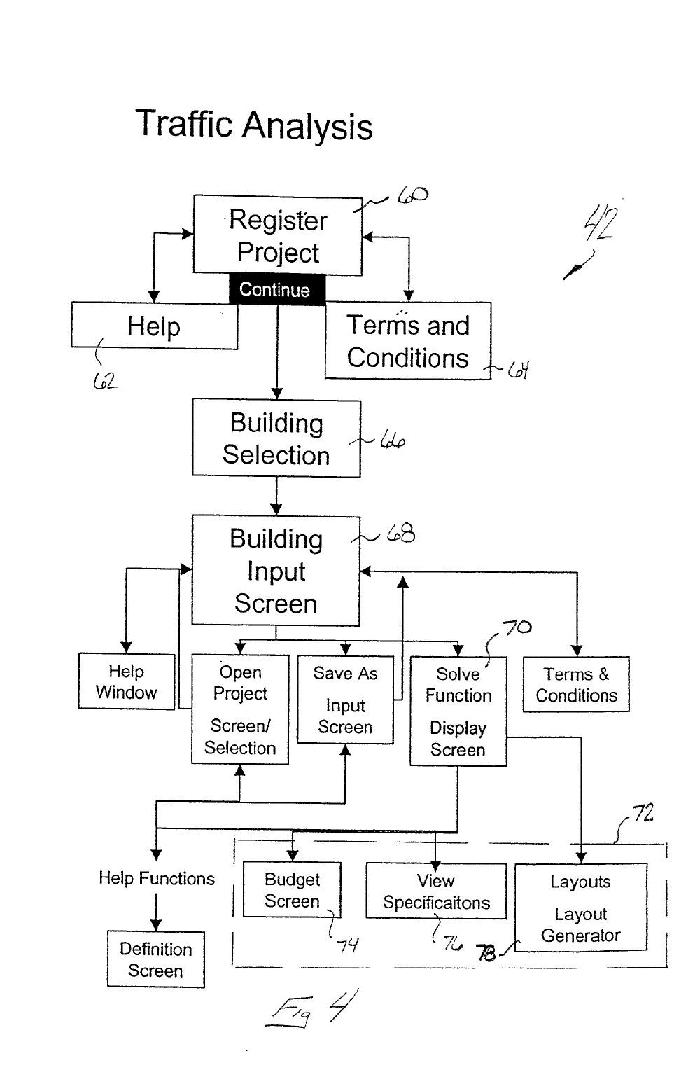

12. FIG. 3 illustrates a user interface feature of this invention.

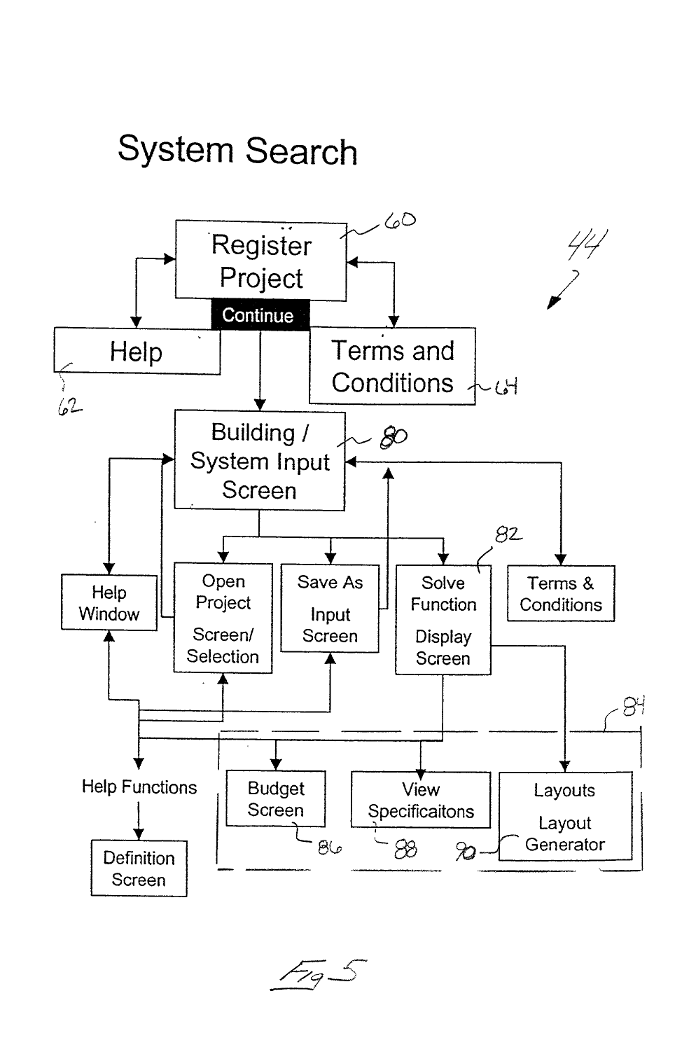

13. FIG. 4 schematically illustrates the operation of one design module designed according to this invention.

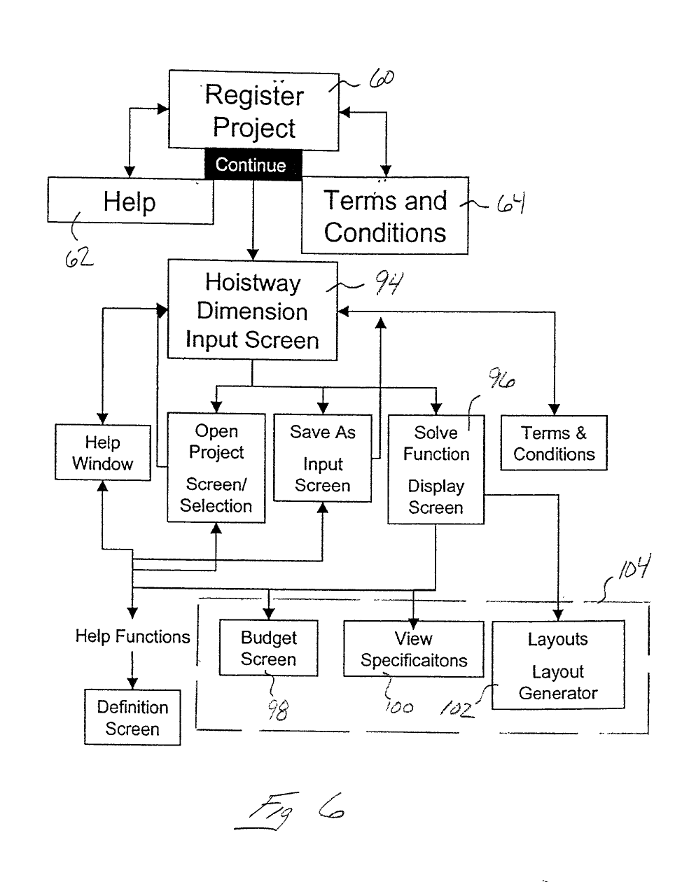

14. FIG. 5 schematically illustrates features of another design module designed according to this invention.

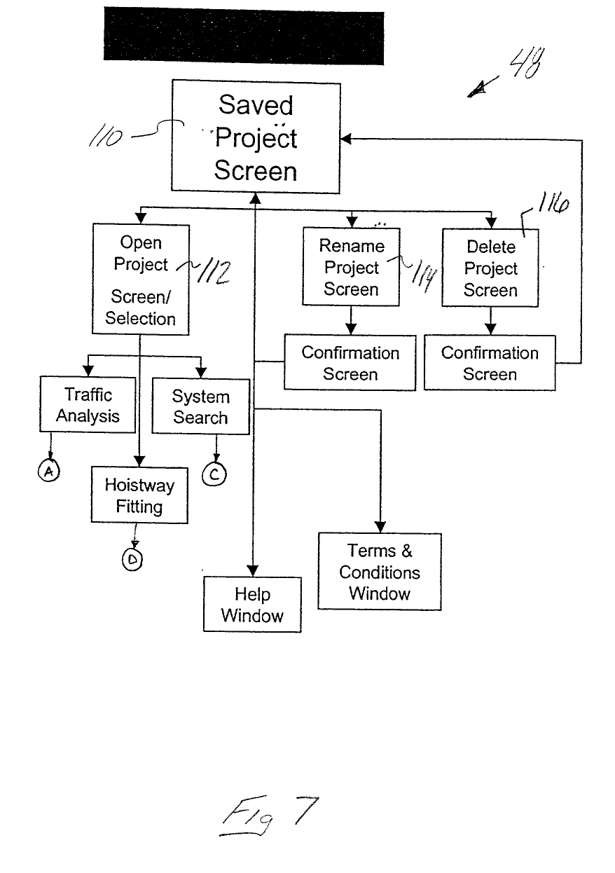

15. FIG. 6 schematically illustrates features of a third design module designed according to this invention.

### DETAILED DESCRIPTION OF THE PREFERRED EMBODIMENT

16. A system 20 that facilitates designing elevator systems for buildings is schematically illustrated in the figures. A customer or user, which typically would be an architect or building engineer for example, utilizes a conventional computer terminal 22 to input information regarding a particular location where an elevator system is desired. A communication link 24, such as the internet, allows the customer or user to be at any desired remote location.

17. A communication module 26 facilitates communication between the customer or user terminal 22 and a design module 28 that utilizes information received from the user and provides suggested elevator design information.

18. The preferred embodiment of the system 20 primarily constitutes computer software. The drawings that accompany this description provide a schematic illustration of a preferred general arrangement and functional concepts for purposes of discussion. The various ways that portions of the system 20 are segmented or arranged need not be as illustrated. Further, the use of the term “module” within this specification should not be interpreted in a limiting sense. A module designed according to this invention may consist of multiple subroutines or calls within a computer program, for example. Alternatively, a module may be a dedicated portion of software code to accomplish a specific task as may be needed.

19. The communication module 26 preferably includes a remote interface module 30 that guides the user to the appropriate portions of the system 20. An example remote interface module provides a web page with a plurality of selections from which the user is able to choose. One of the user selections 32 guides the user to the design facilitation process provided by the system 20.

20. By making the appropriate selection, the user is guided at 34 to identify themselves to the system 20. The user preferably is provided with the ability to register as a user of the system at 36 to facilitate frequent use of the system. Alternatively, a home page 38 directs the user to moving forward in the design process. The communication module 26 may facilitate the user's access and use of other applications 40 besides those dedicated to the elevator design process.

22. The design module 28 preferably includes three individual modules that each handle different types of information from the user as part of the elevator design process. A first module 42 determines elevator system characteristics based primarily upon expected passenger traffic patterns. A second module 44 determines elevator design information based upon building characteristics of the building in which the elevator system will be installed. A third module 46 determines elevator design information based upon dimensional information about the hoistway within the building where the elevator system will be installed.

22. The system 20 preferably allows a customer or user to repeatedly access existing projects 48, which preferably are stored in computer memory 50. The individual projects may be stored in individual files or otherwise maintained in computer storage, for example. The preferred embodiment includes an administrator module 52 that facilitates individual user's separate projects and keeps them in a manner that allows the user to access the projects as needed. Alternatively, the administrator module 52 facilitates using project information stored on the user's computer.

23. The communication module 26 preferably facilitates the user choosing what kind or type of information that the user will provide to the system to develop the elevator system design information. In the illustrated example, the communication module 26 facilitates the user choosing among the three types of information handled by the first module 42, second module 44 or third module 46, respectively. Of course, a system designed according to this invention may handle less than three or more than three types of information. Given this description, those skilled in the art will be able to determine how best to incorporate a variety of choices for the individual customer or user.

24. When the customer or user begins a project, system 20 preferably prompts the individual to register the project at 60. Project registration facilitates the user gaining repeated access to an ongoing project. Further, project registration allows a representative of the elevator company to access the system 20 and communicate directly with the customer regarding any questions or issues that arise during the elevator design or installation process.

25. Throughout the customer's use of the system 20, it is preferable to provide access to help 62 and to the various terms and conditions regarding the different portions of the system 20 to guide the user through the process.

26. As best seen in FIG. 4, when the user chooses to gain information regarding the elevator system design based upon expected passenger traffic flow, a building selection module 66 operates to direct the user to choose from among various types of buildings using a building input module 68. In one example, the customer is provided with one or more computer screens containing a plurality of options describing different types of buildings from which the user may choose. Example choices include an office building, an industrial building, a warehouse building, a parking structure or a hotel. When a building type does not match a preprogrammed selection, the system 20 preferably prompts the user to choose another type of information or to consult a company representative.

27. The first module 42 preferably utilizes predetermined system suggestions corresponding to the type of building. The system best suited for a building type preferably is determined independently from the operation of the system 20. In other words, it is preferred to predetermine what systems will be well-suited for a given building type and to program the system 20, accordingly. Those skilled in the art who have the benefit of this description will be able to match up building types with suitable systems prior to incorporating such relationships into the system 20. It is known, for example, that office buildings have different traffic patterns at different times during normal business hours.

28. Once the individual makes the appropriate choices as guided by the system 20, a solutions module 70 preferably utilizes the information provided by the user and automatically determines a suggested elevator system design. An output module 72 provides the design information to the user. In the preferred embodiment, the user preferably has access to a variety of design information. Pricing or budgeting information 72 allows the user to determine the approximate cost of the proposed system. Specifications 76 preferably are automatically generated to describe the elevator system and its various components. Drawings 78 preferably are provided with architectural and engineering details.

29. The types of drawings provided by the system 20 may be customized depending on the individual customer or user. For example, an architect may require more detailed information then a developer or potential building owner. The system 20 preferably is designed to accommodate different levels of detail in the various information that is provided by the output module 72.

30. The second module 42 preferably determines elevator design information based upon building characteristics provided by the customer. Example building characteristics include the number of floors, location, intended use, and structural composition. The second module 44 preferably provides an input screen 80 to guide the user in providing the characteristic information. Solutions module 82 determines the elevator design information responsive to the customer's input. In the preferred embodiment, the second module 44 preferably does not provide an overall elevator system design, but rather provides a list of elevator components that would be suitable based upon the information provided. From this listing, the customer may select from among the various proposals and choose the components that will best suit their particular need.

31. An output module 84 preferably provides the information to the customer in the form of pricing information 86, specifications 88 and drawings 90. Although a separate output module 84 is illustrated in FIG. 5, compared to the output module 72 illustrated in FIG. 4, in some example implementations of this invention, a single output module is shared by the various design modules 42, 44 and 46.

32. The third alternative that a customer has in the described example is to provide information regarding the elevator hoistway within the building where the elevator system will be located. A hoistway dimension input interface 94 guides the customer through the process of providing the information necessary for the module 46 to make the determination. In a preferred embodiment, the third module 46 preferably provides a listing of elevator systems that will be accommodated within the hoistway, based upon the information from the customer. A solutions module 96 automatically determines this information, which is provided to the user through an output module 98. Again, the forms of output to the customer preferably include budgeting or pricing information 100, specifications 102 and drawings 104.

33. In one example, the budgeting and specification information are provided in a format compatible with most word processing programs that are commercially available. The drawing information preferably is provided in a CAD readable format or a format that is useable with other document reading programs as commercially available. Given this description, those skilled in the art will be able to choose from among the various formats and programs that are available to facilitate the customer gaining access to the information generated by the system 20.

34. Another feature of this invention preferably is to include a translation module 110 that facilitates converting the information from the customer and the elevator system design information provided to the customer between various languages. Since the system 20 is intended to be useable by a customer at any location around the world, the translation module 110 facilitates a representative of the elevator company accessing the information on a given project and being able to interpret that information as necessary to facilitate communications with the customer for providing further design guidance or to facilitate the actual sale of the elevator system components.

35. Given this description, those skilled in the art will be able to develop the necessary software code that accomplishes the results provided by this invention.

36. The preceding description is exemplary rather than limiting in nature. Variations and modifications to the disclosed embodiment may become apparent to those skilled in the art that do not necessarily depart from the purview and spirit of this invention. The scope of legal protection given to this invention can only be determined by studying the following claims.

We claim:

1. A system for developing designs of elevator systems, comprising:
a design module that facilitates automatically developing elevator system design information based upon a selected kind of system information provided by a user; and
a communication module that automatically facilitates interaction between a user at a remote location and the design module.

2. The system of claim 1, wherein the communication module is operative to guide the user to select from among a plurality of kinds of system information and facilitates providing the information provided by the user to a corresponding portion of the design module.

3. The system of claim 1, including a pricing module that automatically generates pricing information based upon the information provided by the user and information generated by the design module.

4. The system of claim 1, including a translation module that automatically translates information provided by the user or information provided by the design module into another language.

5. The system of claim 1, wherein the design module includes
a first module that automatically develops elevator system design information based upon building characteristics information provided by the user;
a second module that automatically develops elevator system design information based upon passenger traffic information provided by the user;
a third module that automatically develops elevator system design information based upon elevator system characteristics provided by the user.

6. The system of claim 5, wherein the communication module facilitates the user choosing at least one of the first, second or third modules depending on the selected kind of information for developing the elevator system design.

7. The system of claim 5, wherein the first module provides information regarding a plurality of elevator system components from which the user may choose to incorporate into the elevator system.

8. The system of claim 5, wherein the second module provides a plurality of building classification choices to the user and automatically provides the elevator system design information in response to the classification choices made by the user.

9. The system of claim 5, wherein the third module utilizes hoistway dimensional information provided by the user and responsively automatically provides information regarding at least one elevator system that will be adaptable to the hoistway.

10. The system of claim 1, wherein the communication module and the design module comprise computer software.

11. The system of claim 10, wherein the computer software is on a first computer and the user utilizes a second computer located remote from the first computer and wherein the communication module facilitates communication between the user and the system over the internet.

12. The system of claim 1, including an information module that automatically provides elevator system design information to the user in the form of at least one of a drawing or a specification.

13. A computer readable medium containing a plurality of instructions that are executable by a computer for developing designs of elevator systems, comprising:
a first set of instructions that facilitates automatically developing elevator system design information based upon a selected kind of system information provided by a user; and
a second set of instructions that automatically facilitates interaction between a user at a remote location and a computer that uses the first set of instructions.

14. The computer readable medium of claim 13, wherein the first set of instructions includes
a first module that automatically develops elevator system design information based upon building characteristics information provided by the user;
a second module that automatically develops elevator system design information based upon passenger traffic information provided by the user;
a third module that automatically develops elevator system design information based upon elevator system characteristics provided by the user.

15. The computer readable medium of claim 14, wherein the second set of instructions facilitates the user choosing at least one of the first, second or third modules depending on the selected kind of information for developing the elevator system design.

16. The computer readable medium of claim 14, wherein the first module provides information regarding a plurality of elevator system components from which the user may choose to incorporate into the elevator system responsive to the building characteristics information provided by the user.

17. The computer readable medium of claim 14, wherein the second module provides a plurality of building classification choices to the user and automatically provides the elevator system design information in response to the classification choices made by the user.

18. The computer readable medium of claim 14, wherein the third module utilizes hoistway dimensional information provided by the user and responsively provides information regarding at least one elevator system that will be adaptable to the hoistway.
